(19) United States
(12) Patent Application Publication
(10) Pub. No.: US 2011/0119476 A1
(43) Pub. Date: May 19, 2011

(54) HARDWARE RESET BUTTON EQUIVALENT SOFTWARE RESET METHOD FOR NETWORK DEVICE

(76) Inventor: Shaowei Dai, Singapore (SG)

(21) Appl. No.: 13/003,877

(22) PCT Filed: Sep. 16, 2009
(86) PCT No.: PCT/SG2009/000347

§ 371 Date: Jan. 13, 2011

(30) Foreign Application Priority Data
Jul. 16, 2008 (SG) 200805364-7

(51) Int. Cl. G06F 9/06

(52) U.S. Cl. 713/2

(57) ABSTRACT

A software reset method that can be used to reset a network device 1 from a network connected computer 2 without relying on user name, password, IP or hardware button is described. It makes use of power up time and MAC address to validate a reset request. The effective state for listening for reset packet 8 will expire after a preset time. A reset request is only considered valid when it is received within a specified preset time after the network device power-up. Since persons have access to the hardware button are also able to power off/on the device, the power-up time could be used as an indication of hardware button pressed when combined with other packet information.

### BACKGROUND OF THE INVENTION

1. Field of Invention

The present invention relates to reset function of network device. In particular, it is a software based reset method which helps administrator to recover the network device when login password or IP is forgotten.

The whole reset process doesn't need pressing hardware reset button. This is of great importance for outdoor network device like WiFi Access Point. In such device, the reset button is normally hard to reach.

2. Description of the Prior Art

Reset function is to bring the network device to a known state or factory state(factory reset). Applying reset or factory reset to a network device is sometimes unavoidable for network devices. To name a few of the scenarios that leads to such operation: loss of password or loss of IP is most frequently encountered scenarios.

When this happens, administrator needs a way to restore the device to a known state. Most of network device vendor provides a reset button to achieve this. When pressed for certain time, the device will go back to the state as just out of factory, hence the name factory-reset.

The current industry relies on a hardware reset button for reset or factory reset function. But this faces difficulty in outdoor or some indoor environment. In this environment, the network device like WiFi AP is installed to a high position. And most likely it is hard to reach.

In the outdoor network device industry, anything exposed to the outside has to be carefully designed so as to meet the requirement of water proof and security. At the time of this writing , vendors resort to the following solutions for the reset function:
Provides a reset button that will not affect the water proof requirement by carefully designed casing.
Provide a reset button inside the casing. This avoids the hurdles of exposing reset button to outside. But it makes the reset function very inconvenient. Administrator needs to open the casing to reset or factory reset the device.
Pull the reset button wire down to the indoor environment. Then the reset button itself is reachable to administrator.

There is also a login controlled software reset function in most network device. But user can only invoke this function after login. This method has no use when user forget the account information and IP of the network device. Because it relies on user name and password for verification, it can't replace the hardware button.

The invention has been carried out in view of the current solutions and limitations. The objective is to replace the hardware reset button with the software based method so as to avoid the above inconvenience and reduce costs.

The major advantage of this invention is to allow administrator to factory reset a network device remotely just like a reset button is pressed. With the elimination of a hardware button, an outdoor network device could be easily reseted from an indoor computer even when password or IP is lost.

The challenges faced by a hardware reset button equivalent software based reset method are:
1. The method must provide the same level of security as in hardware button method. There must be a way to ensure that only administrators that have access to the reset button can make a successful reset using this method. Otherwise, this method can be easily used as a Deny of Service attack.
2. The method must not rely on password for validation of a reset request. Since the purpose of this reset could be to recover the password, any method relying on password may defeat the purpose.

### SUMMARY OF THE INVENTION

In order to achieve the said objective and meet the challenges, a new parameter: timing is introduced to the reset method. This is the key concept in this invention. The fact that a person who can press the reset button should also be able to power off/on the network device gives us another way to verify that the reset is requested by an authorized person.

Instead of using a hardware button, the present invention use 2 conditions as an indication for a valid reset request:
1. A valid data packet containing the reset command is received.
2. The time that the said packet is received must be within a preset period from power up time.

The reset process comprises the following steps from the administrator's point of view:
1. administrator power up(off followed by on) the network device
2. administrator run software reset utility on a computer that is connected to the said network device.
3. The said reset utility will transmit reset command packet to the network device. The communication between reset utility and network device is based on MAC address.
4. The reset utility will feedback the result of this reset command to administrator.

The network device will have a task running from beginning for this reset function. It will go through the following steps.
1. The initial setup for listen to data packet generated by the said software reset utility.
2. If the up time for the device is within certain preset period, it will listen for the reset data packet. A valid reset data packet will trigger the network device to do reset(or factory reset) and reboot.
3. If the up time for the device exceeds certain preset amount, the task will silently be closed. The network devices normal function continues.

The steps and state diagram for administrator and network device is illustrated in FIGS. 2 and 3 respectively.

### BRIEF DESCRIPTION OF THE SEVERAL VIEWS OF THE DRAWINGS

A preferred form of the present invention is illustrated in the accompanying drawings in which:

FIG. 1 illustrate the typical environment where this reset method could be used.

FIG. 2 illustrate the steps administrator will carry out to reset a network device.

FIG. 3 illustrate the activity diagram of the reset method related task inside the network device.

### DETAILED DESCRIPTION OF THE PREFERRED EMBODIMENTS

In the following description, the preferable embodiment will be explained based on the accompanying drawings . It shall be apparent to one skilled in the art, however, the invention may be practiced without such details.

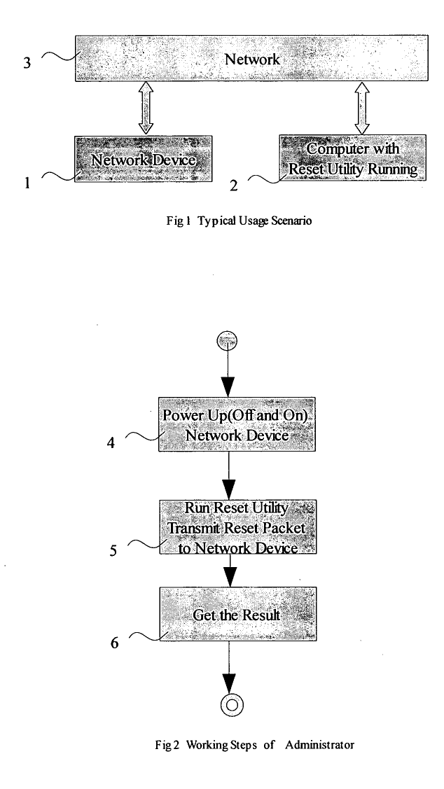

As shown in FIG. 1, network device 1, computer 2 on which reset utility will be run, and network connection 3 that connects 1 and 2 constitutes the environment where the invented reset method could be used.

A computer 2 could be any device that has a network interface and can run a reset utility. The reset utility will transmit the data packet when instructed by administrator.

A network 3 could be any LAN switch, hub or just cross cable.

With the setup environment ready, the administrator can reset the network device 1 following steps in FIG. 2.

The first step is to power up(off/on) the device. This step serves to reset the device's internal up time timer. All operation must be conducted within certain preset time after the device is up. For those outdoor network devices that support Power Over Ethernet. This could be done in the indoor environment by pull out and plug in the cable.

Step 5 in FIG. 2 is the step to run the reset utility. This utility will transmit some reset request command packet. The packet will contain commands to reset the device and MAC of the device for the commands to apply. It could use UDP/IP protocol for communication. Or it can use the same protocol as the login controlled reset function. One example for the reset utility would use multicast or broadcast UDP packet for this reset command transmission.

Step 6 will feedback the result to administrator on the successfulness of the reset operation.

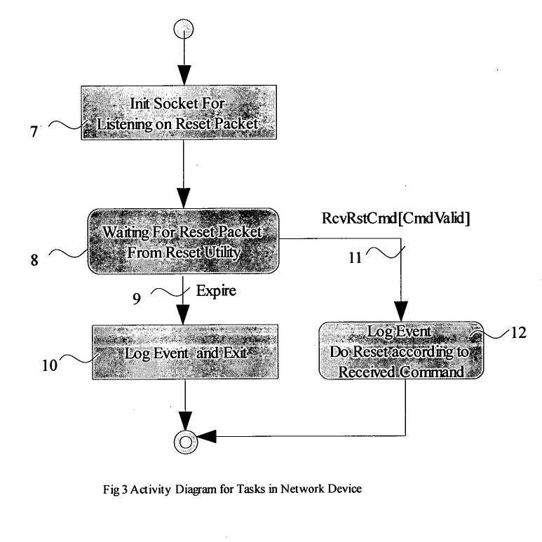

On network device 1, the internal activity diagram is illustrated as in FIG. 3. After power up, the step 7 in network device 1 will be carried out. So the network device 1 could listen for reset packet that would be generated by reset utility.

After initial setup, network device 1 will enter into state 8. In this state, 2 events will trigger action.
If the preset timing expires as in transition 9, the network device 1 will just log this event and silently end this reset related task. Normal function of the device will continue.
If a valid reset packet is received as in transition 11, the network device 1 will carry out the reset command accordingly. And normally a reboot will follow.

In transition 11, the received reset packet will be checked based on MAC address information for validity. Only a valid reset command will be carried out by the network device.

What is claimed is:

1. A software based reset method that comprising:
a reset utility that generates reset request packet and runs on a computer which is connected to a network device and
a software task or function for accepting reset request that runs on a network device which is the target for the reset operation and p1 an algorithm for identifying a valid reset request packet by comparing user non-configurable information inside the reset request packet with the information contained in the network device and
the following steps:
powering down and then powering up the network device by user,
sending out a reset request packet by reset utility,
identifying a valid reset request packet by the targeted network device using the algorithm,
resetting the network device to settings according to informations from the valid reset request packet.

2. The method of claim 1, wherein the said reset utility generates reset request packet including various configuration parameters that the said network device supports.

3. The method of claim 1, wherein the said software task or function will only be in effective state for a preset period of time after the said network device power-up. The effective state herein means the task or function will listen for reset request packet.

4. The method of claim 3, wherein the said reset request packet contains MAC address of the network device and configuration parameters.

5. The method of claim 1, 3, 4 wherein the said algorithm makes use of the said network device's up time and MAC address information for validity check of the reset request packet.

6. The method of claim 5, wherein the algorithm identifies a valid reset request packet when both of the below two conditions are met:
a matching MAC for the network device is found in the reset request packet and
the reset request packet is received within certain preset time range.
The method of claim 4, 5 or 6, wherein the said reset request packet and algorithm can use any information not supposed to be configurable by user in place of MAC.
